(19) United States
(12) Patent Application Publication
(10) Pub. No.: US 2006/0026059 A1
(43) Pub. Date: Feb. 2, 2006

(54) Advertising method for digitally rented movies

(76) Inventor: Aryk Erwin Grosz, Canyon Country, CA (US)

Correspondence Address: Aryk Grosz, 18716 Nathan Hill Dr, Canyon Country, CA, 91351, US

(21) Appl. No.: 10/902,460

(22) Filed: Jul. 30, 2004

(51) Int. Cl. G06Q 30/00

(52) U.S. Cl. 705/14; 705/26

(57) ABSTRACT

An invention directed to providing an advertising means by way of digitally rented movie viewing. Digitally rented refers to the act of downloading or streaming movies over the internet for the purpose of viewing for a limited time period or a limited number of times. Advertising messages are placed around the perimeter viewing area and/or in the viewing area of a movie watched on a viewer's digital display device.

### FIELD OF THE INVENTION

The present invention relates to advertising during the course of a digitally rented movie or film by inserting the advertising messages in and around the viewing area of the movie frame.

### BACKGROUND

Cost reduction of purchasing a computer and maintaining internet access as well the reduction in downloading time of graphical information is making the internet ever-increasingly more suitable for movie downloading and watching over the internet. The increase in popularity of the internet prompted advertisers to target internet users by displaying banners on internet sites.

Currently, there are internet movie rental services that charge a set fee for downloading or streaming full length movies to be viewed over the internet on the computer. For example, www.movielink.com allows users to download or stream a movie from their database (the movie database is very similar to that found at Blockbuster Video).

Although advertising over the internet has many shapes and forms, no one has utilized or integrated advertising in movie's streamed or downloaded over the internet. With the use of advertisements during the playback of digitally rented movies, rented movies could become ever increasingly more popular by making this form of movie rentals cheaper or free for the consumer.

### OBJECT OF THE INVENTION

The present invention has the object of providing free movie access over the internet to the public.

A further object of the invention is to reduce internet movie piracy while providing legal access to all available movies.

Another object of this invention is to provide adequate compensation for the movie distributors through advertising fees paid by the advertising space renters.

### DRAWINGS

FIG. 1 (see page 11)—an example of what a digitally rented movie watcher will see as he/she looks at a digital display device when he/she watches a movie through an application utilizing said advertising method.

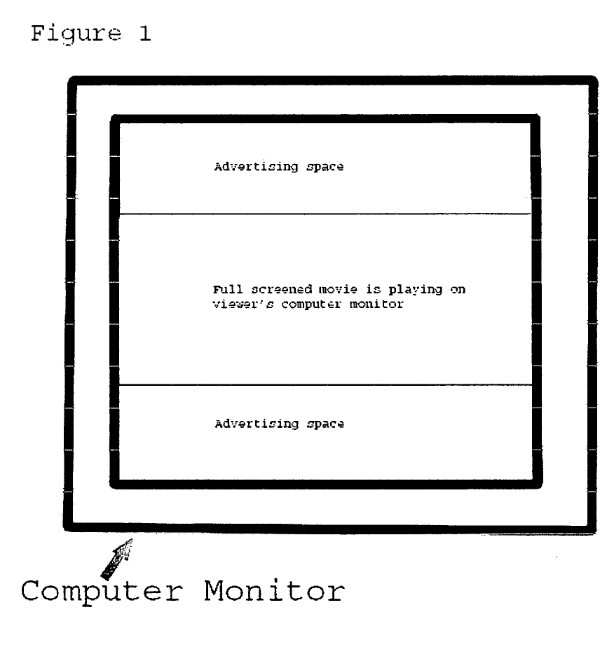

### DETAILED DESCRIPTION OF THE INVENTION

In order to provide consumers free internet movie access, advertising space is sold to sponsors. Conventional movies use a wide screen format, leaving black bands on the top and bottom of the digital viewing area while the film is playing. Advertisers' banners will be displayed here for a fee that will be used to pay the royalties to the movie companies. Should the film fit the viewing area exactly (being non-widescreen), it will be letterboxed so that ad(s) can be placed anywhere in the black area surrounding the movie where so chosen.

The movie watchers will be exposed for the entire time or any portion thereof of the movie presentation to stationary and or animated advertising messages. Considering the relatively small size of a banner to the size of the entire digital viewing area, the interference with the movie will be minimal. Although the focus of the spectator will be directed to the movie, the ad will be directed to the subconscious of the spectator or to casual viewing by the spectator.

To have access to free movies the internet user will have to download a special application that ensures that the advertisements are in an unobstructed view while watching the movie and that the movie is guarded against potential piracy. This special application can be in the form of a browser plug-in, applet, or separate software entirely, thus requiring that the software be downloaded and installed. The software will make sure that, if downloaded, the movie does not remain on a person's hard drive for more than a certain period of time and that it is not copied. The advertising messages will always be unobstructed. Unobstructed means that the viewer will not be able to move the window or application in which the movie is playing off the viewable digital screen so as to separate the advertisements from the movie. The software used to view the movie and display the ads will be designed to be resized to the user's liking so that he/she can either full-screen it or watch the movie in a smaller window while still being able to work on his/her computer.

Compared to other forms of advertising, advertisers using this method will have a guaranteed audience for the amount of time their ad is displayed since the viewers will be looking at the screen watching the film, and the ads around it. Note: this method includes any animated or interactive ads such as shockwave. This method will greatly reduce movie piracy over peer-to-peer networks because internet users will be able to watch the same movies for free and at faster speeds if streamed, making it more convenient and without prejudice to the distributors.

For example, an individual downloading a 700 megabyte movie from a peer to peer network may take up to several days to download. This same individual can go to the website implementing this patented method and be able to watch it for free immediately or within a short time delay.

The individual can stream the movie and will only need to wait a few minutes for a buffer to be created. Streaming technology from Windows Media, Real, or any other streaming technology will be implemented in the software to ensure maximum compatibility. It is easy to see why a user would rather use this method of watching films.

The advertisements can not only be put around the viewing area of the digitally rented movie, but also inserted inside the digital movie frames as a watermark. Both the advertisements inserted into the movie frame and around the movie can be controlled by a direct internet connection with a server or can be downloaded and stored for immediate access.

This patent provides for the advertising method by which complete movies can be downloaded or streamed for free or a minimal cost and viewed within a certain time frame along with the banner ads supporting the movie distributors and the cost of the service. The preferred method of delivering the free movies is by streaming within the software created allowing for the efficient use of advertising time over a given period.

Advertising throughout the digitally rented movie is not limited to banners around the movie viewing area, but also through use of commercials at intermissions throughout the movie, much like watching a movie on TV. If streamed, the viewer will not be able to fast forward or skip this advertisement getting almost guaranteed exposure for the sponsor. If downloaded and watched, the software will not have a seek or fast forward/rewind option during the playing of advertisements. This is to ensure no ads entered as commercials get skipped. These advertisements/commercials together with the banners will pay for the free distribution of the movie over the internet. The frequency of these commercials inserted into the film can be controlled without actually inserting them into the file from which the user is streaming or downloading from. Instead, the special software which has been described above will pause the movie while it is being watched and enter the commercial and then resume playback of the movie from where it was paused.

What is claimed:

1. An advertising method during the viewing of a digitally rented movie/film by attaching said advertising messages around the perimeter viewing area of the movie/film.

2. An advertising method as in claim 1 whereas the advertising messages are inserted into the viewing area of the digitally rented movie/film.

3. A method for implementing said advertising method of claim 1 and claim 2 through the use of a computer application or applet.

4. A method for controlling the length of time that said advertisings of claim 1 and 2 is displayed during the movie/film playback.

5. A method of limiting the resize capabilities of the said application or applet in order to secure said advertising of claim 1 to remain in the viewing area of the digital viewing device.

6. A method of limiting the positioning characteristics of the program or applet referred to in claim 3 to keep said advertising of said claim 1 in the viewing area of a digital viewing device.

7. A method of providing free online movie/film distribution or rental service compensated by said advertising method of claim 1 and/or claim 2.

8. A method of providing free movie/film distribution or rental service compensated by said advertising method of claim 1 and/or claim 2.

9. A method for promoting films using said methods of claim 7 and claim 8.

10. A method whereby said advertising method of claim 1 and/or claim 2 is inserted into the video file of the movie/film played.

11. A method whereby said advertising method of claim 1 and claim 2 is separated from the video file of the movie.

12. A method whereby said advertising method of claim 10 and claim 11 is integrated within said application.

13. A method of displaying said advertising of claim 1 and claim 2 through said application whereby advertising messages are downloaded and stored on the user's computer and called upon by said program during the playback of the movie.

14. A method of displaying said advertising of claim 1 and 2 through said application whereby advertising messages are:
controlled from a remote location.
downloaded temporarily.
cycled during the movie playback.

15. A method of displaying said advertising of claim 2 by way of advertising messages inserted within the viewing area of the movie as a watermark.
